(19) United States
(12) Patent Application Publication
(10) Pub. No.: US 2007/0277868 A1
(43) Pub. Date: Dec. 6, 2007

(54) Apparatus able to track sunlight by three angles for photovoltaic power generation

(75) Inventors: Bin-Juine Huang, Taipei (TW); Fu-Sheng Sun, Sindian City (TW); Hsiao-Wei Liang, His chi Town (TW)

Correspondence Address: BIRCH STEWART KOLASCH & BIRCH, PO BOX 747, FALLS CHURCH, VA, 22040-0747, US

(73) Assignee: RADISTAR CORP.

(21) Appl. No.: 11/522,452

(22) Filed: Sep. 18, 2006

(30) Foreign Application Priority Data
Jun. 2, 2006 (TW) 95119756

(51) Int. Cl. H02N 6/00

(52) U.S. Cl. 136/246

(57) ABSTRACT

Apparatus able to track sunlight by three angles for photovoltaic (PV) power generation includes: a solar cell module; a solar cell holder; an angle-adjustable platform; a driving motor; a holding pillar and a tracking sensor. The apparatus for PV power generation can generate electric power at three specific angles in a day. The tracking sensor can track the position change of the sun by utilizing the driving mechanism to switch among different positioning statuses. Through the optimized design and the cooperation of the tracking sensor and the positioning mechanism, the apparatus for PV power generation of the present invention can achieve a highest efficiency elevation of the electric power generation by minimum tracking motions.

### BACKGROUND OF THE INVENTION

1. Field of the Invention

The present invention relates to the improvement of the apparatus for photovoltaic power generation, and more particularly, to the simple apparatus able to track sunlight by three angles for photovoltaic power generation which can largely raise the electric power generation efficiency.

2. Description of the Prior Art

Please refer to FIG. 1, which is a schematic diagram of a conventional photovoltaic (PV) power generation system. A solar cell 1′ is fixed on the ground mainly by a set of fixed-type holder 2′ to generate the electric power. The light-receiving surface of the solar cell 1′ faces the right-south, and the angle between the solar cell 1′ and the horizontal plane is normally set to be the same as the latitude of its installed location.

Owing to the sun moves from the east to the west in the sky during a day, the sunlight just can directly irradiate on the solar cell 1′ of the fixed-type PV power generation system in the noon period during a day. The incident angle of the sunlight affects the intensity of the sunlight irradiated on the solar cell 1′, and so as to affect the generation quantity of the electric power. Accordingly, the solar cell 1′ can generate the maximum electric power only when being directly irradiated by the sun, and the generation quantity of the electric power in the other time during a day will decrease because of the obliquely incident sunlight.

If it is wanted to raise the generation efficiency of the electric power for the solar cell 1′, apparatus for tracking the movement of the sun to make the solar cell 1′ always right face the sun will be needed. This kind of the tracking apparatus can raise the generation efficiency of the electric power, but relatively, it also increases the system complexity and cost. And it will consume some portion of the electric power to track the sun. There are some crafted sunlight tracking apparatus adopting the double-axis design, the rotation platform installed with the solar cell have a south-northern axis and an east-western axis which can rotate respectively. And, the south-northern and east-western rotation can be controlled by using a sunlight sensor and the feedback control technique to accurately track the sun. However, this double-axis tracking mechanism is very complex and expensive. And moreover, it has high breakdown probability, therefore it is hard to popularize it. Consequently, how to design the simple and cost-effective sunlight tracking apparatus to raise the generation efficiency of the electric power and lower the cost is a very important issue to promote the application of the solar energy.

### SUMMARY OF THE INVENTION

In order to solve the aforementioned problems, one object of the present invention is to provide apparatus able to track sunlight by three angles for PV power generation.

One object of the present invention is to provide apparatus able to track sunlight by three angles for PV power generation, the electric power generation efficiency is raised through the simple and reliable design of the tracking technique of the present invention.

One object of the present invention is to provide apparatus able to track sunlight by three angles for PV power generation, which can generate electric power at three specific angles in a day. The tracking sensor can track the position change of the sun by utilizing the driving mechanism to switch among different positioning statuses.

One object of the present invention is to provide apparatus able to track sunlight by three angles for PV power generation, the apparatus for PV power generation of the present invention can achieve a highest efficiency elevation of the electric power generation by minimum tracking motions through the optimized design and the cooperation of the tracking sensor and the positioning mechanism.

To achieve the objects mentioned above, one embodiment of the present invention is to provide apparatus for PV power generation, which includes: a solar cell holder; a solar cell fixed to the solar cell holder; a driving motor driving the solar cell holder to rotate and adjust the solar cell to a specific positioning direction; an angle-adjustable platform fixed to the solar cell holder and used to adjust an elevation angle of the solar cell; a holding pillar supporting the solar cell holder and the angle-adjustable platform and having a sleeve fixed thereon; and a tracking sensor set on the solar cell, wherein the tracking sensor includes: a first light-sensing element, a second light-sensing element and a light-blocking plate set therebetween.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram of a conventional PV power generation system;

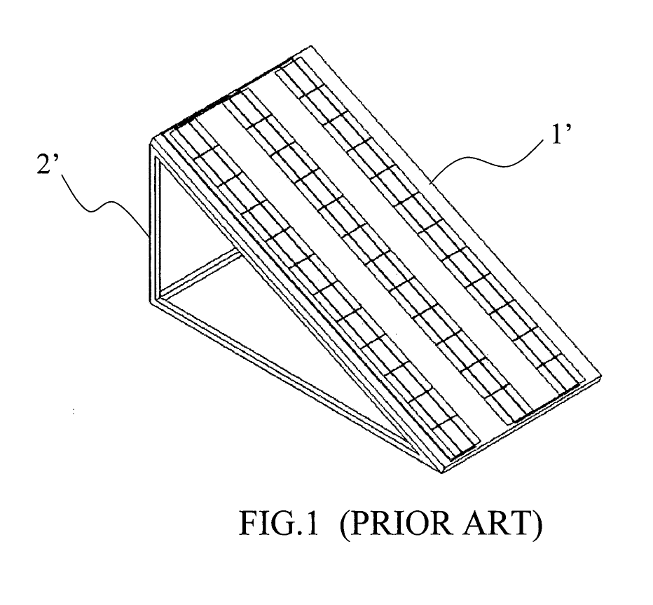

FIG. 2 is a schematic diagram to demonstrate the integral structure of the apparatus for PV power generation according to one embodiment of the present invention;

FIG. 3 is a schematic diagram to demonstrate the structure of a positioning mechanism of the apparatus for PV power generation according to one embodiment of the present invention;

FIG. 4 is a schematic diagram to demonstrate the installation and setup of the apparatus for PV power generation according to one embodiment of the present invention;

FIG. 5 is a schematic diagram to demonstrate the structure of a tracking sensor of the apparatus for PV power generation according to one embodiment of the present invention;

FIG. 6 is a schematic diagram to demonstrate the driving circuit of a driving motor of the apparatus for PV power generation according to one embodiment of the present invention;

FIG. 7A, FIG. 7B and FIG. 7C are schematic diagrams to demonstrate the positioning and tracking of the apparatus for PV power generation according to one embodiment of the present invention;

FIG. 8A, FIG. 8B and FIG. 8C are schematic diagrams to demonstrate the positioning and tracking of a positioning mechanism of the apparatus for PV power generation according to one embodiment of the present invention; and

FIG. 9 is a comparison figure to compare the received irradiation quantity from the sun at different latitudes of the apparatus for PV power generation according to one embodiment of the present invention.

### DESCRIPTION OF THE PREFERRED EMBODIMENT

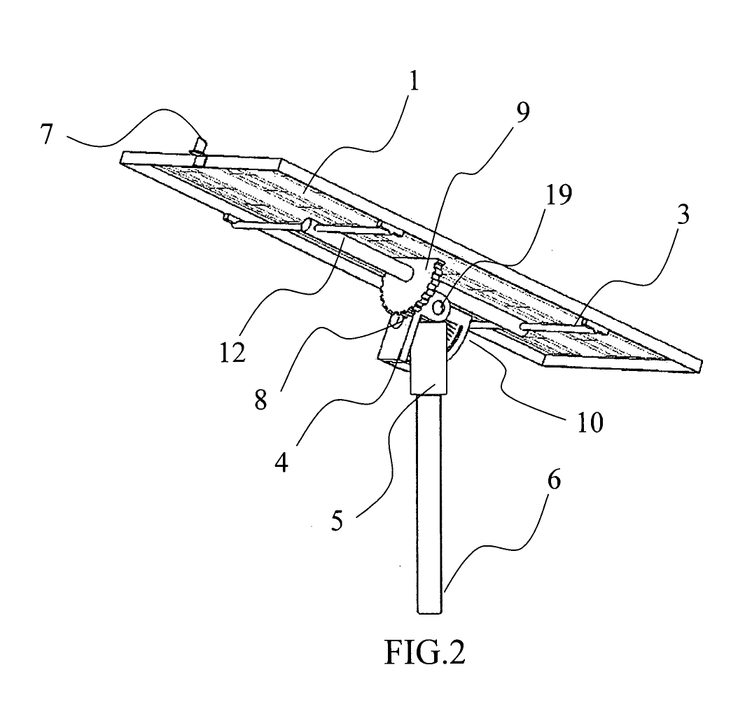

FIG. 2 is a schematic diagram to demonstrate the integral structure of the apparatus for PV power generation according to one embodiment of the present invention. The present embodiment as shown in FIG. 2, the apparatus for PV power generation includes: a solar cell 1; a solar cell holder; an angle-adjustable platform 4; a driving motor 8; a holding pillar 6; and a tracking sensor 7. The solar cell 1 is fixed to the solar cell holder which includes: a holder main-body 3; a rotary axis 12 joined to the holder main-body 3 and fixed to the angle-adjustable platform 4; and a driving gear 9 coupled to the rotary axis 12 and used to drive the whole solar cell holder to rotate.

Continuing the above description for the present embodiment, the driving motor 8 is fixed to the angle-adjustable platform 4 to drive the solar cell holder to rotate and adjust the solar cell 1 to a specific positioning direction. The positioning statuses include a reset-positioning status, an east-positioning status and a west-positioning status. The angle-adjustable platform 4 is fixed to the rotary axis 12 of the solar cell holder and used to adjust an elevation angle of the solar cell 1. The holding pillar 6 having a sleeve 5 fixed thereon is used to support the solar cell holder and the angle-adjustable platform 4, wherein the angle-adjustable platform 4 is coupled to the sleeve 5 by a joint 19, and thereby, the elevation angle read from the dial 10 can be adjusted.

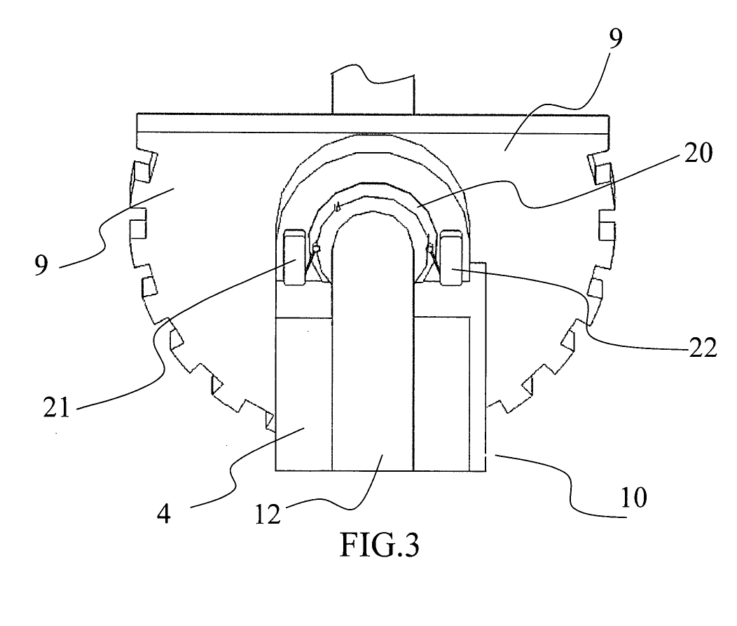

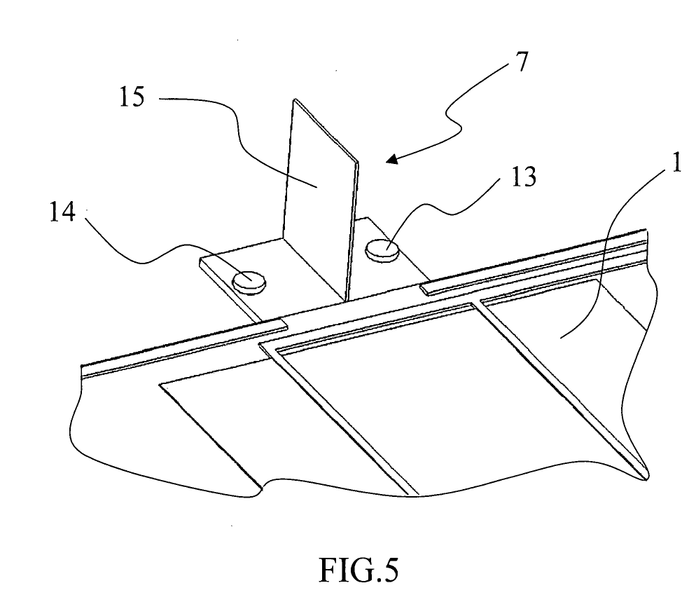

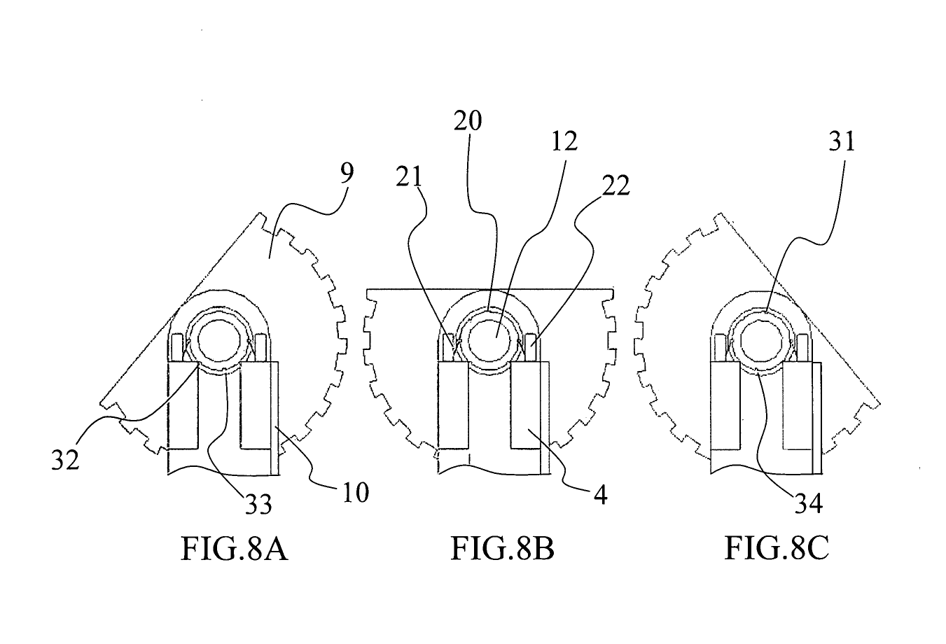

Besides, the tracking sensor 7 is set on the solar cell 1, such as on a lateral side of it. Please refer to FIG. 5, the tracking sensor 7 includes a first light-sensing element 13, a second light-sensing element 14 and a light-blocking plate 15 set therebetween. Please refer to FIG. 2 and FIG. 3 continuously, the solar cell holder further includes a positioning disc 20 and two positioning switches 21, 22. The positioning marks 31, 32, 33 and 34 are inscribed on the positioning disc 20 (As shown in FIG. 8A and FIG. 8C).

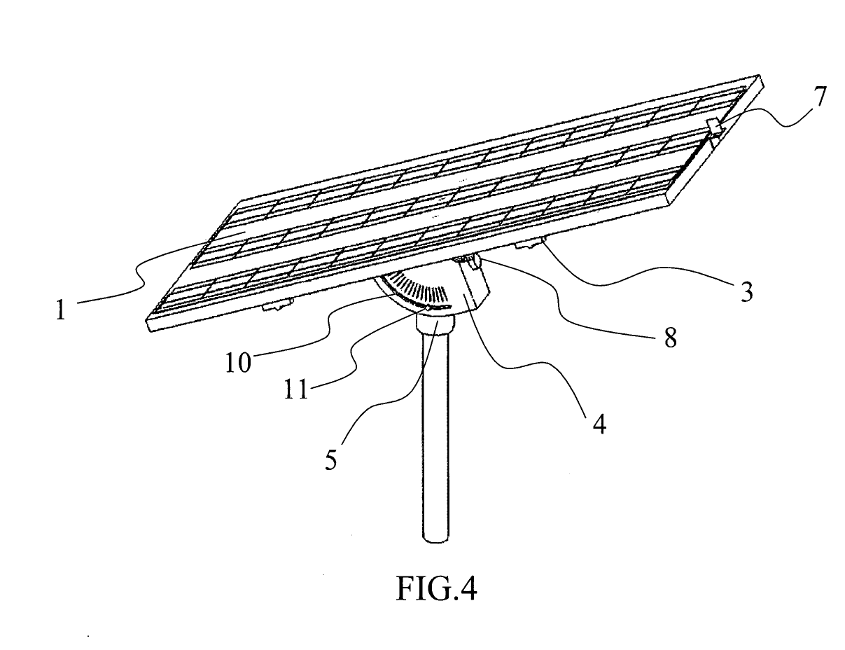

FIG. 4 is a schematic diagram to demonstrate the installation and setup of the apparatus for PV power generation according to one embodiment of the present invention. The setup steps are described as following. Firstly, the solar cell 1 is fixed on the solar cell holder which is driven by the driving motor 8 to rotate eastward and westward around the rotary axis 12 to match the position of the sun. The driving motor 8 and the rotary axis 12 are simultaneously fixed on the angle-adjustable platform 4, and the angle-adjustable platform 4 is coupled to the sleeve 5 by a joint 19, and thereby, the elevation angle can be adjusted. The angle-adjustable platform 4 includes a dial 10, by which the elevation angle can be read. The angle-adjustable platform 4 is locked to a required angle by a fixing screw 11 to match the latitude. The sleeve 5 is fixed on the holding pillar 6 to make the solar cell 1 face the right-south.

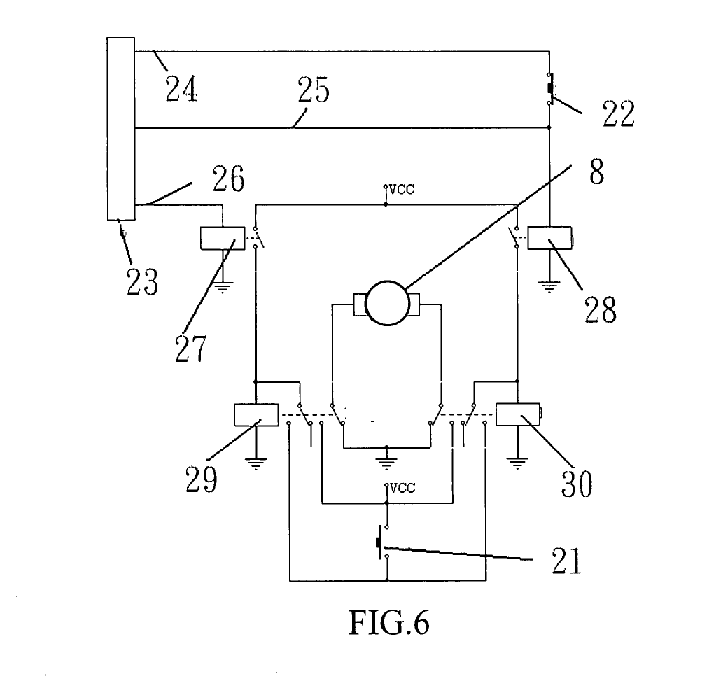

Please refer to FIG. 5 and FIG. 6. The tracking sensor is set on a lateral side of the solar cell 1, the light-blocking plate 15 is set between the first light-sensing element 13 and the second light-sensing element 14. The first light-sensing element 13 is set in the eastern side of the light-blocking plate 15, and the second light-sensing element 14 is set in the western side of the light-blocking plate 15. The signals from the first light-sensing element 13 and the second light-sensing element 14 are transmitted to a control circuit board to proceed the signal comparison by a comparator 23 therein. When the sun moves from the eastern side to the western side of the light-blocking plate 15, the shadow of the light-blocking plate 15 will move from the western side to the eastern side until covering the first light-sensing element 13. After the signal comparison is completed by the comparator 23, a signal is transmitted by a signal line 26 to magnetize a relay 27 and then a relay 29 is switched on. The driving motor 8 rotates clockwise to drive the driving gear 9 to rotate the solar cell holder westward. After the rotation of the solar cell 1 is completed, the signal of the signal line 26 is vanished and the relay 27 is open-circuited. The positioning switch 21 leaves the positioning mark of the positioning disc 20 to close the circuit, and then the circuit is on an on-state. The relay 29 is kept magnetization through the supplied current from the positioning switch 21, and the driving motor 8 keeps rotate clockwise. When the rotated angle of the solar cell holder reaches 50 degrees, the positioning switch 21 will touch the positioning mark of the positioning disc 20 to open the circuit, and then the circuit is on an off-state. The relay 29 loses power, and the driving motor 8 ceases to rotate.

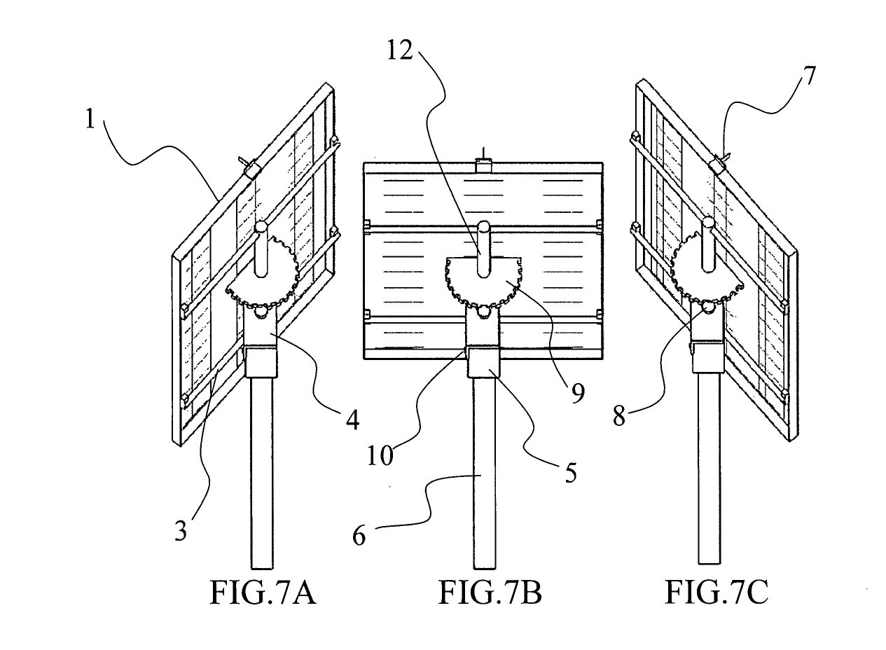

Please refer to FIG. 7A, FIG. 7B, FIG. 7C, FIG. 8A, FIG. 8B and FIG. 8C, which are schematic diagrams to demonstrate the positioning and tracking of a positioning mechanism of the apparatus for PV power generation according to one embodiment of the present invention. As shown in FIG. 7B and FIG. 8B, the solar cell holder keeps on facing orthogonally upward when the system is in a reset-positioning status. After the daybreak, the first light-sensing element 13 will be irradiated by the sun because the sun rises from the east, and then it will generate a signal. The second light-sensing element 14 is covered by the shadow of the light-blocking plate 15. Please refer to FIG. 6 simultaneously, after the signal comparison is completed by the comparator 23, a signal is transmitted by a signal line 25 to magnetize a relay 28 and then a relay 30 is switched on. The driving motor 8 rotates counterclockwise to drive the driving gear 9 to rotate the solar cell holder eastward. After the rotation of the solar cell 1 is completed, the shadow of the light-blocking plate 15 leaves the second light-sensing element 14, and the signal of the signal line 25 is vanished after the signal comparison is completed by the comparator 23. The relay 28 is off, and the positioning switch 21 leaves the positioning mark 32 to close the circuit, and then the circuit is on an on-state. The relay 30 is kept magnetization through the supplied current from the positioning switch 21, and the driving motor 8 keeps rotate counterclockwise. When the rotated angle of the solar cell holder reaches 50 degrees, the positioning switch 21 will touch the positioning mark 33 of the positioning disc 20 to open the circuit, and then the circuit is on an off-state. The relay 30 loses power and the driving motor 8 ceases to rotate, the solar cell holder stops at the east-positioning status as shown in FIG. 7A and FIG. 8C. At the meantime, the first light-sensing element 13 and the second light-sensing element 14 are simultaneously irradiated by the sun, and the solar cell holder is locked to a standstill. In the present invention, the solar cell holder rotates eastward by an angle of about 40 to 60 degrees when the solar cell holder shifts from the reset-positioning status to the east-positioning status.

Continuing the above explanation, when approaching the noon, the sun moves toward the west and the first light-sensing element 13 is gradually covered by the shadow of the light-blocking plate 15. After the signal comparison is completed by the comparator 23, a signal is transmitted by the signal line 26 to magnetize a relay 27 and then a relay 29 is switched on. The driving motor 8 rotates clockwise to drive the driving gear 9 to rotate the solar cell holder westward. After the rotation of the solar cell 1 is completed, the shadow of the light-blocking plate 15 leaves the first light-sensing element 13, and the signal of the signal line 26 is vanished after the signal comparison is completed by the comparator 23. The relay 27 is off, and the positioning switch 21 leaves the positioning mark 33 of the positioning disc 20 to close the circuit, and then the circuit is on an on-state. The relay 29 is kept magnetization through the supplied current from the positioning switch 21, and the driving motor 8 keeps rotate clockwise. When the rotated angle of the solar cell holder reaches 50 degrees, the positioning switch 2 1 will touch the positioning mark 32 of the positioning disc 20 to open the circuit, and then the circuit is on an off-state. The relay 29 loses power and the driving motor 8 ceases to rotate, the solar cell holder returns back to the reset-positioning status as shown in FIG. 7B and FIG. 8B. At the meantime, the first light-sensing element 13 and the second light-sensing element 14 are simultaneously irradiated by the sun, and the solar cell holder is locked to a standstill.

Then, during the afternoon, the sun keeps move toward the west and the first light-sensing element 13 is gradually covered by the shadow of the light-blocking plate 15. After the signal comparison is completed by the comparator 23, a signal is transmitted by the signal line 26 to magnetize the relay 27 and then the relay 29 is switched on. The driving motor 8 rotates clockwise to drive the driving gear 9 to rotate the solar cell holder westward. After the rotation of the solar cell 1 is completed, the shadow of the light-blocking plate 15 leaves the first light-sensing element 13, and the signal of the signal line 26 is vanished after the signal comparison is completed by the comparator 23. The relay 27 is off, and the positioning switch 21 leaves the positioning mark 32 of the positioning disc 20 to close the circuit, and then the circuit is on an on-state. The relay 29 is kept magnetization through the supplied current from the positioning switch 21, and the driving motor 8 keeps rotate clockwise. When the rotated angle of the solar cell holder reaches 50 degrees, the positioning switch 21 will touch the positioning mark 31 of the positioning disc 20 to open the circuit, and then the circuit is on an off-state. The relay 29 loses power and the driving motor 8 ceases to rotate, the solar cell holder stops at the west-positioning status as shown in FIG. 7C and FIG. 8A. At the meantime, the positioning switch 22 touches the positioning mark 34 of the positioning disc 20 and close the circuit, and then the circuit is on an on-state. The first light-sensing element 13 and the second light-sensing element 14 are simultaneously irradiated by the sun, and the solar cell holder is locked to a standstill. In the present invention, the solar cell holder rotates westward by an angle of about 40 to 60 degrees when the solar cell holder shifts from the reset-positioning status to the west-positioning status.

When the day comes into the dark, both the first light-sensing element 13 and the second light-sensing element 14 are not irradiated by the sun and don't generate signals. After the signal comparison is completed by the comparator 23, a signal is transmitted by a signal line 24 to magnetize a relay 28 through the positioning switch 22 and then a relay 30 is switched on. The driving motor 8 rotates counterclockwise to drive the driving gear 9 to rotate the solar cell holder eastward. After the rotation of the solar cell 1 is completed, the positioning switch 22 leaves the positioning mark 34 of the positioning disc 20 to form an open-circuit. The signal of the signal line 24 is vanished, and the relay 28 is off. The positioning switch 21 leaves the positioning mark 31 to close the circuit, and then the circuit is on an on-state, and the relay 30 is kept magnetization through the supplied current from the positioning switch 21. The driving motor 8 keeps rotate counterclockwise. When the rotated angle of the solar cell holder reaches 50 degrees, the positioning switch 21 will touch the positioning mark 32 of the positioning disc 20 to open the circuit, and then the circuit is on an off-state. The relay 30 loses power and the driving motor 8 ceases to rotate, the solar cell holder stops at the reset-positioning status as shown in FIG. 7B and FIG. 8B. Although the first light-sensing element 13 and the second light-sensing element 14 are not irradiated by the sun and don't generate signals at this time, a signal is continuously transmitted by the signal line 24 after the signal comparison is completed by the comparator 23. But the positioning switch 22 has left the positioning mark 34 of the positioning disc 20 to form an open-circuit, the relay 28 cannot be magnetized. The solar cell holder is locked to a standstill.

Please refer to FIG. 6 again, a double-blade and double-tossing relay is used to control the driving motor 8 to rotate clockwise or counterclockwise in the present invention, and it forms a self-holding loop until the mechanism reaches a specific position by cooperating with a positioning switch. And the other positioning switch assures that the mechanism will return eastward to the reset-positioning status only when the mechanism is in the west-positioning status.

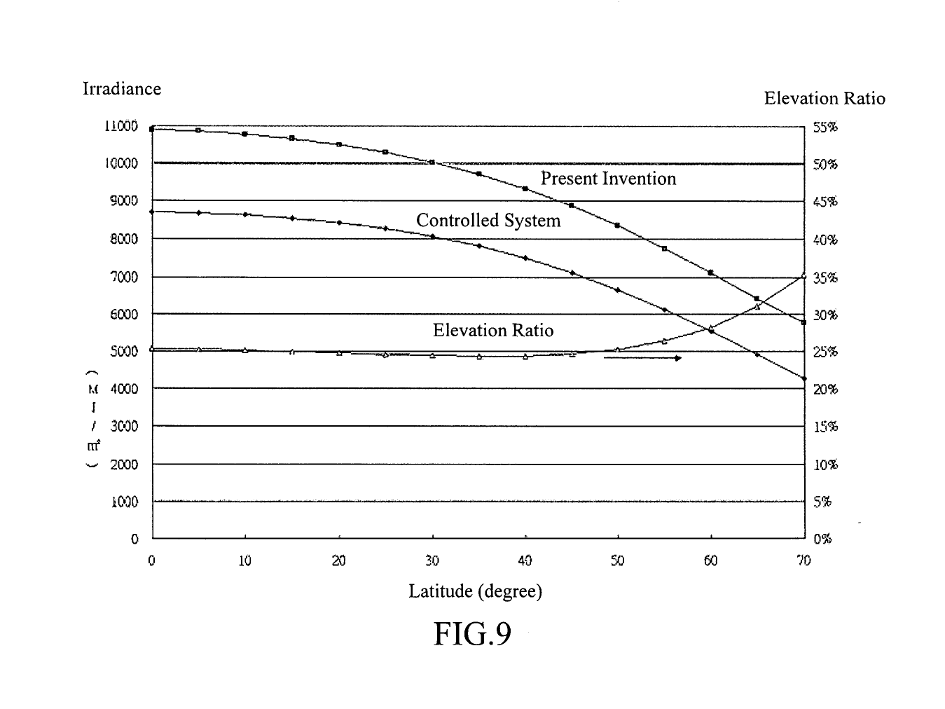

FIG. 9 is a comparison figure to compare the received irradiation quantity from the sun at different latitudes of the apparatus for PV power generation according to one embodiment of the present invention. The optical calculation result of the received irradiance (MJ/m²) from the sun is based on the assumption that the apparatus for PV power generation is installed at different latitudes and its elevation angle is the angle that the mechanism can receive the maximum irradiance from the sun at that location. The comparison of the difference between the present invention and the controlled system of a conventional PV power generation system is also shown in FIG. 9: the lateral axis represents different latitudes; the curve with rhombus data points represents the annual irradiance received by the controlled system; the curve with square data points represents the annual irradiance received by the apparatus able to track sunlight by three angles for PV power generation according to the present invention; the curve with triangle data points represents the elevation ratio of the annual irradiance received by the present invention comparing to which of the controlled system.

To continue the above description, it shows that the elevation ratio of the annual irradiance received by the present invention comparing to which of the controlled system is obviously raised, averagely raised by about 25% and more than 30% in the region of high latitude. Please refer to FIG. 5, the height of the light-blocking plate 15 is cotangent 25 (about 2.1445) times the distance between the bottom of the light-blocking plate 15 and the center of the first light-sensing element 13 or the second light-sensing element 14 in the present invention. In addition, the elevation angle is approximately equal to the degree of the latitude where the apparatus for PV power generation is located in the region where the latitude is lower than 45 degrees, and the elevation angle is about 45 degrees in the region where the latitude is greater than 45 degrees.

According to the abovementioned description in the present invention, the solar cell is set on a solar cell holder which is driven by the driving motor to rotate eastward and westward to match the position of the sun. The driving motor is set on an angle-adjustable platform which elevation angle can be adjusted according to different latitudes. The combination of the angle-adjustable platform and the sleeve is inserted by a holding pillar already fixed on the ground to complete the installation process.

The present invention utilizes a positioning mechanism driven by a motor to track the position of the sun eastward and westward. The mechanism rotates from the east to the west to match the position of the sun, and stops at three specific fixed angles. Through the detailed optical analysis and calculation for the irradiance from the sun by the inventor, the best three specific fixed angles are: stopping at an angle of 50 degrees eastern to the solar cell holder in the morning period; returning to zero degree relative to the solar cell holder, said, the orthogonally upward position at noon; and stopping at an angle of 50 degrees western to the solar cell holder in the afternoon period. The tracking sensor is set on the same plane with the solar cell, the shadow of the light-blocking plate changes along with the change of the incident angle of the sunlight when the sun moves. When the shadow covers the first light-sensing element in the east side, the tracking mechanism is triggered to rotate toward the next specific position until the positioning sensor touches a positioning mark.

To summarize, the present invention utilizes a tracking technique to raise the electric power generation efficiency through a simple and reliable design. The apparatus for PV power generation can generate electric power at three specific angles in a day, and the tracking sensor can track the position change of the sun by utilizing the driving mechanism to switch among different positioning statuses. The apparatus for PV power generation of the present invention can achieve a highest efficiency elevation of the electric power generation by minimum tracking motions through the optimized design and the cooperation of the tracking sensor and the positioning mechanism.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. Apparatus for photovoltaic power generation, comprising:
a solar cell holder;
a solar cell fixed to said solar cell holder;
a driving motor driving said solar cell holder to rotate and adjust said solar cell to a specific positioning direction;
an angle-adjustable platform fixed to said solar cell holder and used to adjust an elevation angle of said solar cell;
a holding pillar supporting said solar cell holder and said angle-adjustable platform and having a sleeve fixed thereon; and
a tracking sensor set on said solar cell, wherein said tracking sensor comprises: a first light-sensing element, a second light-sensing element and a light-blocking plate set therebetween.

2. The apparatus for photovoltaic power generation according to claim 1, wherein said solar cell holder comprises:
a holder main-body;
a rotary axis joined to said holder main-body and fixed to said angle-adjustable platform; and
a driving gear coupled to said rotary axis and used to drive said solar cell holder to rotate.

3. The apparatus for photovoltaic power generation according to claim 2, wherein said solar cell holder further comprises a positioning disc and two positioning switches.

4. The apparatus for photovoltaic power generation according to claim 1, wherein said driving motor is fixed to said angle-adjustable platform.

5. The apparatus for photovoltaic power generation according to claim 1, wherein said angle-adjustable platform comprises a dial.

6. The apparatus for photovoltaic power generation according to claim 5, wherein said angle-adjustable platform is coupled to said sleeve by a joint, and thereby, said elevation angle read from said dial can be adjusted.

7. The apparatus for photovoltaic power generation according to claim 6, wherein said angle-adjustable platform is locked to a required angle by a fixing screw.

8. The apparatus for photovoltaic power generation according to claim 1, wherein said tracking sensor is set on a lateral side of said solar cell.

9. The apparatus for photovoltaic power generation according to claim 1, wherein said solar cell holder keeps on facing orthogonally upward in a reset-positioning status.

10. The apparatus for photovoltaic power generation according to claim 9, wherein said first light-sensing element and said second light-sensing element respectively face eastward and westward.

11. The apparatus for photovoltaic power generation according to claim 9, wherein said solar cell holder rotates eastward by an angle of about 40 to 60 degrees when said solar cell holder shifts from said reset-positioning status to an east-positioning status.

12. The apparatus for photovoltaic power generation according to claim 9, wherein said solar cell holder rotates westward by an angle of about 40 to 60 degrees when said solar cell holder shifts from said reset-positioning status to a west-positioning status.

13. The apparatus for photovoltaic power generation according to claim 1, wherein the height of said light-blocking plate is about cotangent 25 times the distance between the bottom of said light-blocking plate and the center of said first light-sensing element or said second light-sensing element.

14. The apparatus for photovoltaic power generation according to claim 1, wherein said elevation angle is approximately equal to the degree of the latitude where said apparatus for photovoltaic power generation is located in the region where the latitude is lower than 45 degrees.

15. The apparatus for photovoltaic power generation according to claim 1, wherein said elevation angle is about 45 degrees in the region where the latitude is greater than 45 degrees.
